(19) United States
(12) Patent Application Publication
(10) Pub. No.: US 2022/0169167 A1
(43) Pub. Date: Jun. 2, 2022

(54) Tailgate With An Integrated Grill

(71) Applicant: Timothy Peterson, Union Grove, WI (US)

(72) Inventor: Timothy Peterson, Union Grove, WI (US)

(21) Appl. No.: 17/540,738

(22) Filed: Dec. 2, 2021

Related U.S. Application Data
(60) Provisional application No. 63/120,333, filed on Dec. 2, 2020.

(51) Int. Cl. B60P 3/36; B62D 33/027; A47J 37/07

(52) U.S. Cl. CPC B60P 3/36; A47J 37/074; A47J 37/0736; B62D 33/0273

(57) ABSTRACT

A tailgate with an integrated grill includes a tailgate body pivotally secured to a rear end of a vehicle. A grill assembly disposed within an interior side of the tailgate body includes a grill grate positioned above a first heating element, a plurality of controls for operating the first heating element, and a pair of compartments positioned adjacent opposing sides of the grill grate. The compartments can be utilized for storing cooking utensils and for other purposes. A fuel supply is secured within a rear storage area of the vehicle. A fuel line coupled to the fuel supply extends through the interior side of the tailgate body and couples to the first heating element. The grill assembly may include additional heating elements such as a gas burners and electric heating elements. The plurality of controls may be utilized to select between different heating elements for different cooking options.

### CROSS-REFERENCE TO RELATED APPLICATIONS

This application claims the benefit of U.S. Provisional Patent Application Ser. No. 63/120,333, filed on Dec. 2, 2020. The above identified patent application is herein incorporated by reference in its entirety to provide continuity of disclosure.

### BACKGROUND OF THE INVENTION

The present invention relates to vehicle tailgates having accessory components, including grills and similar cooking devices. More particularly, the present invention provides a tailgate having an integrated grill which includes multiple heating elements that can be selected by the operator, as well as multiple storage compartments for storing cooking utensils and other items.

Vehicles with tailgate access to rear storage areas such as pickup trucks and SUVs are often used for recreational activities as well as transportation. Such vehicles provide maximal storage space for equipment and often provide additional utility once parked. Some of the recreational activities may include outdoor cooking with grills and the like. While pickup trucks and SUV's provide additional storage area for transporting grills and similar cooking devices, such devices are also bulky and heavy, making it difficult to load them into the vehicle without assistance. It can also be difficult to secure the grill or other cooking device within the vehicle such that it does not move around and damage itself or the vehicle during transport. Further, the cooking devices will take up space that can be otherwise used to store other items. The cooking device often also requires the storage of accessory items, such as utensils, for example, which further reduces the available storage space within the vehicle. Even if the vehicle can accommodate a large grill or other similar device, it can be difficult and time consuming to unload and reassemble the grill for use. In order to address these concerns, the present invention provides users with a unique truck tailgate equipped with a grill, burners, and other heating elements for cooking food, as well as several compartments for utensils and other cooking accessories. Since the grill and other cooking elements are integrated within the vehicle tailgate, many of the above problems are remedied by the present invention.

Devices have been disclosed in the known art that relate to vehicle tailgates having integrated cooking mechanisms. These include devices that have been patented and disclosed in patent application publications. However, the devices in the known art have several drawbacks. For example, these typically only provide a single cooking element, which makes it difficult to prepare large quantities of food or foods that include different types of preparation. Further, the devices in the known art often lack the necessary storage compartments to store cooking utensils and other important items in close proximity to the cooking devices that are being utilized. Additionally, the devices in the known art typically provide only one fuel source, whereas the present invention can include multiple fuel sources that are selectable by the user, further adding to the overall utility of the present invention.

In light of the devices disclosed in the known art, it is submitted that the present invention substantially diverges in design elements from the known art, and consequently it is clear that there is a need in the art for an improvement to existing tailgate accessory devices, particularly those including cooking elements. In this regard the present invention substantially fulfills these needs.

### SUMMARY OF THE INVENTION

The present invention provides a tailgate with an integrated grill wherein the same can be utilized for providing a customizable and easily accessible cooking device that is integrated within a vehicle for convenience. The tailgate with an integrated grill generally includes a tailgate body pivotally secured to a rear end of a vehicle and a grill assembly disposed within an interior side of the tailgate body. The grill assembly includes a grill grate positioned above a first heating element, a plurality of controls for operating the first heating element, and a pair of compartments positioned adjacent opposing sides of the grill grate. A fuel supply is secured within a rear storage area of the vehicle. A fuel line coupled to the fuel supply extends through the interior side of the tailgate body and couples to the first heating element. The grill assembly can be utilized to prepare food quickly easily without requiring the transportation or assembly of a separate grill.

One object of the present invention is to provide a tailgate with an integrated grill that includes multiple accessory storage compartments for storing cooking utensils and other items so they are close at hand while cooking.

Another object of the present invention is to provide a tailgate with an integrated grill that includes multiple types of heating elements that are selectable by the user.

A further object of the present invention is to provide a tailgate with an integrated grill that can be easily covered when not in use, allowing the tailgate to function as normal when needed.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the tailgate with an integrated grill with the grill cover in an open position.

FIG. 2 shows a perspective view of an embodiment of the tailgate with an integrated grill with the grill cover in a closed position.

FIG. 3 shows a perspective view of an embodiment the tailgate with an integrated grill detailing the first compartment and the controls.

FIG. 4 shows a perspective view of an embodiment the tailgate with an integrated grill detailing the removable grill grates and the second compartment.

### DETAILED DESCRIPTION OF THE INVENTION

Reference is made herein to the attached drawings. Like reference numerals are used throughout the drawings to depict like or similar elements of the tailgate with an integrated grill. For the purposes of presenting a brief and clear description of the present invention, a preferred embodiment will be discussed as used for providing a cooking mechanism that is integrated with and storable within a vehicle tailgate. The figures are intended for representative purposes only and should not be considered to be limiting in any respect.

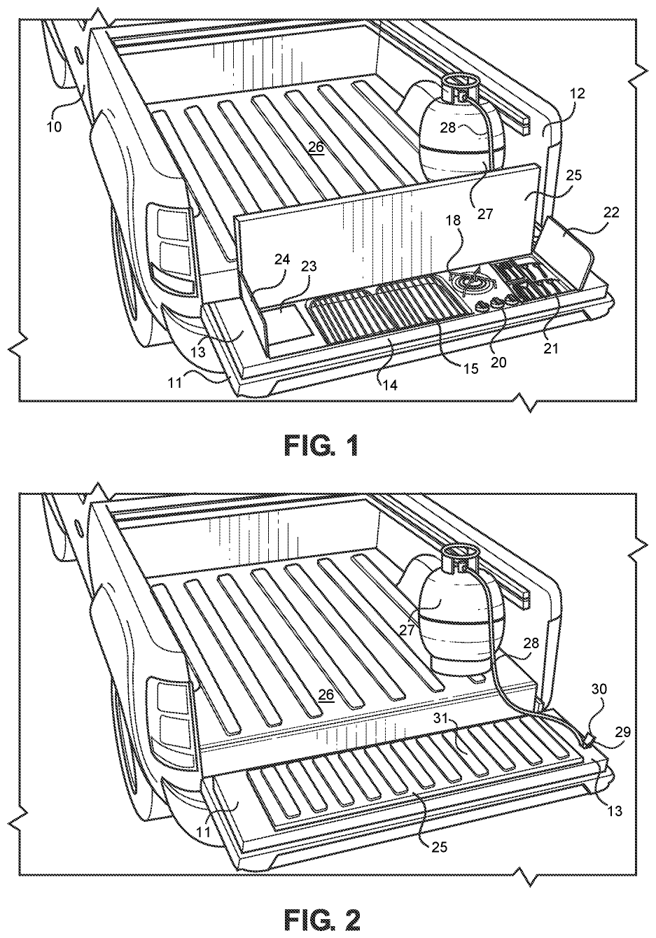

Referring now to FIG. 1, there is shown a perspective view of an embodiment of the tailgate with an integrated grill with the grill cover in an open position. The present invention includes a tailgate body 11 pivotally secured to a rear end 12 of a vehicle 10. In the shown embodiment, the vehicle 10 is a pickup truck. However, any suitable type of vehicle having a rear fold-down tailgate body 11 may be utilized. While not illustrated, the tailgate body 11 can include various latches and the like for securing the tailgate body 11 in a closed position, as with any typical fold-down vehicle tailgate. In order to protect the tailgate body 11 from the heat generated by the integrated grill, the tailgate body 11 and other portions of the vehicle may include a heat resistant paint as an outer covering.

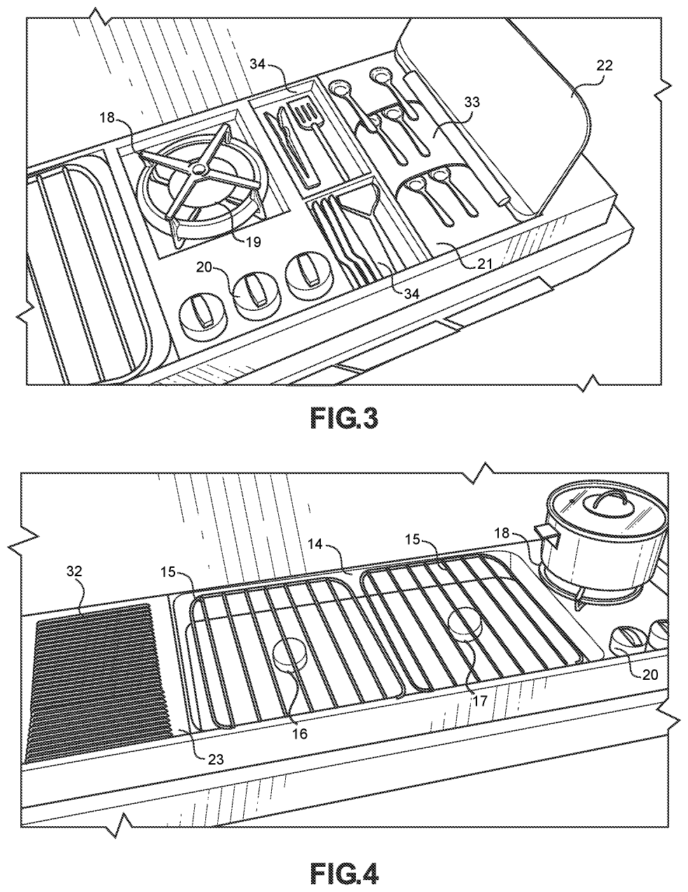

A grill assembly 14 is disposed within an interior side 13 of the tailgate body 11. The grill assembly 14 can be integrated within the tailgate body 11 at manufacture or may be installed within a portion of tailgate body 11 as an add-on. The grill assembly 14 includes at least one grill grate 15 positioned above at least one heating element, as most clearly visible in FIG. 4. The grill grates 15 are shown as rack-type grates, but may include different cooking surfaces, such as a flat-top griddle for example. The grill assembly 14 includes an additional heating element adjacent the grill grates 15, which is shown as a gas burner 18 in the illustrated embodiment. A plurality of controls 20 are provided for operating the various cooking elements of the present invention. In the shown embodiment, the controls 20 include rotatable knobs, such as gas burner control knobs, for example, but the controls 20 can include any type or combination of buttons, knobs, and the like. The gas burner 18 and other gas-powered heating elements may include electric ignition mechanisms, which can also be operated via the controls 20.

The grill assembly 14 further includes a pair of compartments 21, 23 positioned on opposing sides of the grill grates 15. The compartments 21, 23 provide storage areas that are easily accessible by the operator of the grill assembly 14 even when they are actively cooking or otherwise using the grill assembly 14. Each compartment includes a closure door 22, 24 that can close to cover the compartments 21, 23 until the user needs to access their interiors. The entire grill assembly 14 also includes a cover 25 that is attached to the tailgate body 11. The cover 25 can open to expose the grill assembly 14 for use, and close to cover and protect the grill assembly 14 when not in use.

A fuel supply 27 is secured within a rear storage area 26 of the vehicle. In the shown embodiment, the fuel supply 27 is a propane tank that is secured within the truck bed 26. This positioning allows the user to easily swap out empty tanks with filled tanks as needed. A fuel line 28 couples to the fuel supply 27 and extends through the interior side 13 of the tailgate body 11 and couples to at least one of the heating elements. For example, the fuel line 28 provides propane to fuel the gas burner 18.

Referring now to FIG. 2, there is shown a perspective view of an embodiment of the tailgate with an integrated grill with the grill cover in a closed position. When the grill assembly cover 25 is in the closed position, the tailgate 11 can be utilized as a typical tailgate. The cover 25 includes gripping ridges 31 that facilitate traction when loading and unloading the rear storage area 26 of the vehicle, such as when changing the fuel supply 27, for example. The tailgate body 11 further includes a pivoting access door 30 attached to the interior side 13 of the tailgate body 11. The pivoting access door 30 is configured to selectively provide access to a coupling element 29 for the fuel line 28. The coupling element 29 then connects to various internal lines that transport the fuel to the cooking elements. When the fuel line 28 is disconnected from the coupling element 29, the access door 30 can be closed to cover and protect the coupling element 39. This allows the user to remove the fuel supply 27 and fuel line 28 if additional storage room within the rear storage area 26 of the vehicle is needed.

Referring now to FIG. 3, there is shown a perspective view of an embodiment the tailgate with an integrated grill detailing the first compartment and the controls. In the illustrated embodiment, the first compartment 21 includes a pair of removable trays 34 that can support various items such as utensils or the like. The compartment 21 also includes individual pockets 33 that support utensils or other items such that they are protected and organized. The pivoting lid 22 can be opened to access the compartment 21 or closed to secure the items stored therein. In the shown embodiment, the grill assembly 14 further comprises a stovetop burner 18 having a second heating element 19 operably connected to the fuel supply and the controls 20, and positioned adjacent the removable grill grate on one side and the first compartment 21 on its other side.

Referring now to FIG. 4, there is shown a perspective view of an embodiment the tailgate with an integrated grill detailing the removable grill grates and the second compartment. In the shown embodiment, the second compartment 23 includes a removable rack 32. The rack 32 can support food items or any other desired materials while keeping such materials close at hand for the user of the grilling assembly 14. In the shown embodiment, the grilling assembly includes a pair of heating elements 16, 17 positioned beneath the grill grates 15. The depiction of the heating elements 16, 17 is representative in nature, and as such the physical construction of the heating elements 16, 17 can include any configuration adapted to heat and cook food supported on the grill grates 15. The grill grates 15 are preferably removable so that they may be easily cleaned as needed.

In the shown embodiment, one heating element 16 includes a gas burner or similar gas-powered heating element, while the other heating element 17 includes an electric heating element that is operably connected to a power supply. In one embodiment, the power supply is a rechargeable battery disposed within the tailgate body 11. In another embodiment, the power supply is a direct connection to the vehicle battery. In yet another embodiment, the power supply can be a hardwired connection to a wall outlet or similar AC or DC power source. In these embodiments, the controls 20 includes a heating a heating element selection control configured to select between the gas grill heating element 16, the electric grill heating element 17, and the gas burner 18. The controls 20 may also facilitate operation of any combination of the heating elements simultaneously. This provides the user with the option to select from multiple heating elements depending on current circumstances. For example, if fuel is not readily available for the gas heating elements, the electric heating elements may be utilized. Likewise, if battery power is low and the battery is not currently able to be charged, the gas heating elements may be utilized. Overall, the present invention provides the user with the convenience of multiple types of cooking devices integrated into the vehicle tailgate, which further provides multiple storage compartments. In this way, the present invention gives individuals the ability to cook and prepare meals outdoors during recreational activities without the need for a separate cooking appliance.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, and all equivalent relationships to those illustrated in the drawings and described in the specification are intended to be encompassed by the present invention. Therefore, the foregoing is considered as illustrative only of the principles of the invention. Further, it is not desired to limit the invention to the exact construction and operation shown and described, and accordingly, all suitable modifications and equivalents may be resorted to, falling within the scope of the invention.

I claim:

1) A tailgate with an integrated grill comprising:
a tailgate body pivotally secured to a rear end of a vehicle;
a grill assembly disposed within an interior side of the tailgate body, the grill assembly comprising a grill grate positioned above a first heating element, a plurality of controls for operating the first heating element, and a pair of compartments positioned adjacent opposing sides of the grill grate;
a fuel supply secured within a rear storage area of the vehicle; and
a fuel line coupled to the fuel supply that extends through the interior side of the tailgate body and couples to the first heating element.

2) The tailgate with an integrated grill of claim 1, wherein the grill grate is removable for cleaning purposes.

3) The tailgate with an integrated grill of claim 1, wherein the fuel supply comprises a propane tank and the first heating element comprises a gas burner.

4) The tailgate with an integrated grill of claim 1, further comprising a pivoting access door attached to the interior side of the tailgate body, the pivoting access door configured to provide access to a coupling element for the fuel line.

5) The tailgate with an integrated grill of claim 1, wherein the grill assembly further comprises a stovetop burner having a second heating element operably connected to the fuel supply and positioned adjacent the removable grill grate.

6) The tailgate with an integrated grill of claim 5, wherein the grill assembly comprises a third heating element which is an electric heating element operably connected to a battery power supply.

7) The tailgate with an integrated grill of claim 6, wherein the battery power supply comprises a rechargeable battery disposed within the tailgate body.

8) The tailgate with an integrated grill of claim 6, wherein the battery power supply is a main vehicle battery.

9) The tailgate with an integrated grill of claim 6, wherein the plurality of controls includes a heating element selection control configured to select between the first heating element, the second heating element, and the third electrical element.

10) The tailgate with an integrated grill of claim 1, wherein the pair of compartments comprises a first compartment having a first pivoting cover and a second compartment having a second pivoting cover.

11) The tailgate with an integrated grill of claim 10, wherein the first compartment comprises a pair of recessed trays and a plurality of pockets adjacent the pair of recessed trays.

12) The tailgate with an integrated grill of claim 11, wherein the second compartment comprises a removable rack.

13) The tailgate with an integrated grill of claim 1, wherein the tailgate body includes a heat resistant paint as an outer covering.

14) The tailgate with an integrated grill of claim 1, further comprising a grill assembly cover pivotally connected to the tailgate body and configured to move between a closed position covering the grill assembly and an open position exposing the grill assembly.

15) The tailgate with an integrated grill of claim 14, wherein an outer side of the grill assembly cover includes a plurality of ridges.
